(19) United States
(12) Patent Application Publication
(10) Pub. No.: US 2006/0206399 A1
(43) Pub. Date: Sep. 14, 2006

(54) Method and device for generation of a customer-specific financing offer for a technical system

(76) Inventor: Pierre Robin Niepel, Exton, PA (US)

Correspondence Address: SCHIFF HARDIN, LLP;PATENT DEPARTMENT, 6600 SEARS TOWER, CHICAGO, IL, 60606-6473, US

(21) Appl. No.: 11/366,701

(22) Filed: Mar. 2, 2006

(30) Foreign Application Priority Data
Mar. 2, 2005 (DE) 10 2005 009 558.5

(51) Int. Cl. G06Q 40/00; G06F 7/00; G06F 17/00

(52) U.S. Cl. 705/35; 707/100

(57) ABSTRACT

For a simple generation of a customer-specific data set, particularly for generation of a financing offer for the leasing of medical apparatuses, basic data are stored in a central database and centrally updated. The current basic data are transferred to a portable and decentralized computer dependent on need, and for this, the decentralized computer is temporarily connected with the central database. A selection menu is provided at the decentralized computer, via which selection menu the customer-specific data are recorded. In connection with the basic data, a corresponding financing offer is generated with the aid of a calculation program located on the decentralized computer. This enables a sales agent on site to directly and quickly submit a financing proposal to a customer.

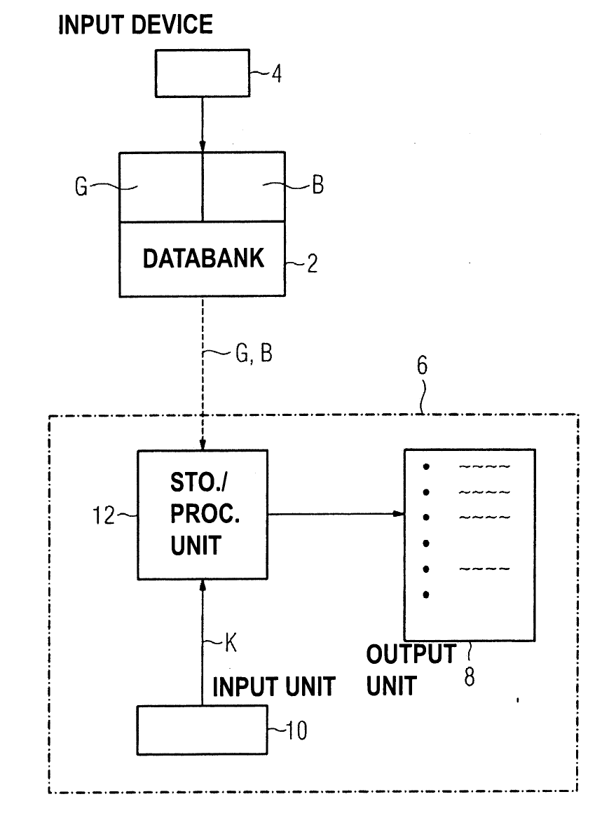

### BACKGROUND

In the sale of cost-intensive technical systems, particularly complex medical examination or diagnosis apparatuses (such as computer tomographs), in addition to the apparatus properties, interesting financing offers are often also of deciding importance in a purchase. Given the sale of a new apparatus in medical technology, an old apparatus is replaced by the new apparatus and charged against the sale price. The apparatuses are also frequently leased.

The problem from a sales perspective is that the individual sales agent must possess sufficient financing information (in addition to the technical information) in order to be able to also act as a financing service person as well. The daily changing conditions for financing businesses (such as the current interest rates of different financial institutions) are sometimes a problem. In the business models today, the sales agent approaches a financing specialist with a financing request; the financing specialist then works out a special, customer-specific financing offer, and, for example, obtains, compares and selects the current financial conditions, such as interest rates, durations, etc., of various banks for this. This is, however, connected with a significant time expenditure and is additionally static, since no different financing concepts can be calculated by the customer on site with this method.

### SUMMARY

The present invention is therefore based on the object to provide a method as well as a device with which a customer-specific financing or leasing offer can be generated in a simple and optimally quick manner.

The object is achieved via a method for generating a customer-specific financing offer for a technical system, comprising: storing basic data comprising technical apparatus data of the system and financing data in a central database; centrally updating the basic data via an input device; temporarily connecting a decentralized computer to the central database; transferring the current basic data to the decentralized computer dependent on need; displaying a selection menu based on the basic data on the decentralized computer; inputting a customer-specific system selection as well as further customer-specific data assisted by the selection menu; generating and outputting, using the basic data and the customer-specific data, a current valid customer-specific financing offer utilizing a calculation program located on the decentralized computer.

It is accordingly provided that basic data (such as the currently best interest rate or leasing rate of different financial service providers, the residual or salvage value of various old apparatuses or old systems, etc.) are stored in a central database and centrally updated via an input device. These basic data hereby comprise apparatus data such as different system or apparatus types, different equipment variants, as well as calculation or financing data such as purchase price, residual value or interest.

The respective updated basic data are transferred to a decentralized and particularly a portable computer, dependent on need. For this, the decentralized computer is temporarily connected with the central database. The central computer can particularly be a laptop or also a PDA (personal digital assistant) which accesses the central database and updates the basic data over an internal corporate network or also over the Internet.

Furthermore, a selection menu based on the basic data is provided on the decentralized computer, with the help of which selection menu the customer requirements (both with regard to the technical embodiment of the system and with regard to the parameters connected with the financing) can be selected and input in a menu-driven manner. In addition to a customer-specific apparatus selection, further customer-specific data are therefore recorded and, using these data together with the basic data, a current valid, customer-specific data set (particularly a financing offer) is generated and output with the aid of a calculation program located on the decentralized computer. The output in this case ensues, for example, on a screen, on a printer, or also in a file.

The decisive advantage of this method is that the sales agent has all current information available onsite for the generation of a financing offer, and can assemble such a financing offer in line with demand during the sales talk. With this, it is not necessary that he resort to a central financial service location. A significant time savings is achieved with this, and the possibility is additionally opened up to play through various scenarios in order to select the best-possible financing offer for the customer.

Both a selection with regard to the apparatus parameters and with regard to relevant calculation parameters for the financing is hereby expediently enabled via the selection menu. In addition to the purchase price of the new apparatus, the residual value of an old apparatus, and the current interest rates, a further calculation parameter may be, for example, the number of the users of the medical system, since the costs for a service contract are frequently determined according to this. These calculation parameters are predetermined fixed in part via the centrally-administered calculation data such as the interest rate. Other calculation parameters such as the number of the users, purchase price of the old apparatus, etc., can be freely edited.

According to an appropriate development, the basic data respectively contain current financing data from various financial services, thus particularly the different interest conditions and financing conditions. Different finance serve-specific financing offers are generated on the basis of these different various financing data of the financial services. A suitable financing offer that is advantageous for the customer is therefore selected on site for the customer. For example, a selection of a suitable financing offer is particularly automatically made, for example, using predeterminable criteria.

Existing, customer-specific old data that are contained in the basic data are hereby preferably accessed. These old data are, for example, information about the old apparatuses, the purchase prices or the residual values of the old apparatuses, number of the users, etc. If such old data are available, an initialization of the corresponding fields in the selection menu advantageously ensues.

In the connection of the decentralized computer with the central database, it is furthermore appropriately checked whether the calculation program located on the decentralized computer is still valid. This occurs, for example, via a comparison of the respective version of the software. The calculation program on the decentralized computer is updated as needed.

The object is furthermore achieved via a device for generation of a customer-specific data set that may be a customer-specific financing offer for a technical system, comprising: a central database comprising stored basic data that can be centrally updated via an input device, the basic data comprising apparatus data of the system and financing data; and at least one portable and decentralized computer that can be temporarily connected with the central database in order to transfer the current basic data dependent on need, the decentralized computer comprising: a selection menu based on the basic data via which a customer-specific system selection as well as further customer-specific data is input; and a calculation program with which a current valid, customer-specific financing offer is generated and output utilizing the basic data and the customer-specific data.

The advantages and preferred embodiments listed with regard to the method are logically also to be transferred to the device.

### DESCRIPTION OF THE DRAWING

An exemplary embodiment of the invention is explained in detail in the following using the single Figure. In a schematic and roughly simplified representation, the drawing shows a block diagram of a device or a system for generation of a financing or leasing offer.

### DETAILED DESCRIPTION OF THE PREFERRED EMBODIMENTS

According to an embodiment illustrated in the single Figure, the system comprises a centrally-administered database 2 on which basic data G,B are centrally administered via an input device 4 and kept up to date. Due to a corresponding access protection, the basic data G, B can only be administered by authorized persons.

In addition to this central unit, the system typically comprises a plurality of decentralized computers 6 which comprise an output unit 8, an input unit 10 as well as a storage and processing unit 12. The computer 6 is, for example, a typical laptop or what is known as a PDA or handheld PC. A calculation program is stored in the unit 12. The decentralized computer 6 is connected as needed with the central database 2, for example, immediately before a sales meeting. The current basic data G,B are hereby transferred to the decentralized computer 6. This occurs, for example, in that a corresponding data table is transferred to the laptop or in that the PDA is synchronized with the central database 2.

The output unit 8 is, for example, a screen or also a printer. The input unit is, for example, a keyboard, a mouse or also a touchscreen which is simultaneously fashioned as an output unit. On the one hand, the basic data comprise apparatus data G as well as calculation data B. The apparatus data G contain apparatus-specific information, particularly of a technical nature. In contrast to this, the calculation data B comprise all data that are necessary for the generation of a financing offer. Furthermore, customer-specific old data can be stored that contain information about the systems used by a customer as well as the number of the users, etc.

After the updating of the data set on the computer 6, this is typically disconnected again from the central database. A customer-specific selection is recorded via the computer 6 on site at the customer via the input unit 10, with the aid of a selection menu shown on the output unit 8. In the event that it is necessary, further customer-specific data K (such as the number of the users) are input. For example, the selection between different apparatus types, between different equipment variants, etc. is thus enabled.

In addition to this, some significant calculation values can also be input such as the desired duration of the leasing or the number of users, which is relevant for an extended service offer. Using the current calculation data, a financing proposal is immediately generated using this data, with the aid of the calculation program stored in the processing unit 12.

A particular advantage of this system is that different apparatuses and/or financing variants can be calculated quickly and without problems. The customer thus immediately receives an overview about the financing conditions.

What is decisive for these advantages is that the central data acquisition (which regularly occurs and occurs in advance of a meeting or other event at which the calculations are performed) ensues via the central database 2. In contrast to this, in the previous known processes, the relevant data for the compilation of the financing was only retrieved when a concrete financing request by a customer was already present. Via the administration of the basic data already occurring in the foreground of a possible customer request, a very efficient and flexible system is achieved which enables a complete support of a customer in a simple manner, both in a technical regard and in regard to financial services.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for generating a customer-specific financing offer for a technical system, comprising:
storing basic data comprising technical apparatus data of the system and financing data in a central database;
centrally updating the basic data via an input device;
temporarily connecting a decentralized computer to the central database;
transferring the current basic data to the decentralized computer dependent on need;
displaying a selection menu based on the basic data on the decentralized computer;
inputting a customer-specific system selection as well as further customer-specific data assisted by the selection menu;
generating and outputting, using the basic data and the customer-specific data, a current valid customer-specific financing offer utilizing a calculation program located on the decentralized computer.

2. The method according to claim 1, further comprising:
enabling, via the selection menu, a selection both with regard to apparatus parameters and with regard to financing parameters.

3. The method according to claim 1, wherein the apparatus data comprise data related to different apparatus types as well as data related to different equipment variants of the system.

4. The method according claim 1, wherein the financing data comprise at least one current purchase price as well as a current interest rate.

5. The method according to claim 1, wherein the basic data contain respective current financing data from various financial services, the method further comprising:
generating different financial service-specific financing offers based on the various financing data of the financial service.

6. The method according to claim 1, wherein the basic data also comprise customer-specific old data that are utilized for the generation of the customer-specific data set.

7. The method according to claim 6, wherein the old data comprise the residual value of an old system.

8. The method according to claim 6, wherein fields with the old data are initialized in a customer-specific selection menu.

9. The method according to claim 1, further comprising, during the connection of the decentralized computer with the central database:
checking whether the calculation program located on the decentralized computer is valid; and
updating the calculation program on the decentralized computer if it is not valid.

10. The method according to claim 1, wherein:
the customer-specific financing offer is generated on site at a location of the customer; and
the central database is located at the manufacturer or distributor of the technical system or apparatus.

11. The method according claim 1, wherein the technical system is a medical system.

12. A device for generating a customer-specific financing offer for a technical system, comprising:
a central database comprising stored basic data that can be centrally updated via an input device, the basic data comprising apparatus data of the system and financing data; and
at least one portable and decentralized computer that can be temporarily connected with the central database in order to transfer the current basic data dependent on need, the decentralized computer comprising:
a selection menu based on the basic data via which a customer-specific system selection as well as further customer-specific data is input; and
a calculation program with which a current valid, customer-specific financing offer is generated and output utilizing the basic data and the customer-specific data.

13. The device according to claim 12, wherein the decentralized computer is a portable laptop or a PDA.
